(19) United States
(12) Patent Application Publication
(10) Pub. No.: US 2011/0242707 A1
(43) Pub. Date: Oct. 6, 2011

(54) HARD DISK DRIVE

(75) Inventors: Yong-Bae YOON, Suwon-si (KR); Hae Jung Lee, Suwon-si (KR)

(73) Assignee: Samsung Electronics Co., Ltd, Suwon-si (KR)

(21) Appl. No.: 13/079,054

(22) Filed: Apr. 4, 2011

(30) Foreign Application Priority Data
Apr. 2, 2010 (KR) 2010-0030245

(51) Int. Cl. G11B 5/23; G11B 21/24

(52) U.S. Cl. 360/294.1; 360/125.03; G9B/21.028; G9B/5.06

(57) ABSTRACT

A hard disk drive includes a magnetic head to write data to a disk by magnetizing the disk using a leakage magnetic flux that leaks in a disk direction through a write gap provided between a write pole to apply a magnetic field to the disk and a shield provided separately from the write pole, and an actuator arm allowing the magnetic head to pivot over the disk. In the hard disk drive, the write gap is asymmetrically formed to a left and a right with respect to a center axis line of the write pole according to a movement direction of the magnetic head when the magnetic head pivots over the disk.

### CROSS-REFERENCE TO RELATED APPLICATIONS

This application claims the benefit of Korean Patent Application No. 10-2010-0030245, filed on Apr. 2, 2010, in the Korean Intellectual Property Office, the disclosure of which is incorporated herein in its entirety by reference.

### BACKGROUND

1. Field of the Invention

The inventive concept relates to a hard disk drive (HDD), and more particularly, to an HDD which may improve tracks per inch (TPI) without changing the width or material of a write head.

2. Description of the Related Art

HDDs are apparatuses to record data on a disk or reproduce data stored in the disk by using a magnetic head. Since a large amount of data may be accessed at high speed, the HDDs are widely being used as an auxiliary memory device of a computer system.

Recently, HDDs are required to have a more data storage capacity and thus the HDDs are gradually being manufactured to have a higher capacity. Although there are many methods to manufacture a high capacity HDD, the easiest method is to increase the TPI.

An easy way to increase TPI is to reduce the size of a write head to write data to a disk. In this case, the write capability of a write head is deteriorated since it is more difficult to reduce the size of a write head without the result that data may not be written correctly.

In other words, in an ideal case, while the size of a write head is reduced to increase TPI, write capability remains unchanged or becomes better. To this end, a write head formed of a new material which can improve reduction in size needs to be developed. However, the development is practically difficult.

To address the above issue, a shingle writing (SWR) method has been suggested in which, when data is written by using a write head, the data is written overlapping the next track (previous track) by about 50% such that about 50% of the data is erased and about 50% of the data is left, and the remaining 50% is read during a read operation.

However, in a conventional HDD, when data is written by using a write head, a magnetic field affects adjacent tracks. Accordingly, during a write operation, when data is written overlapping the next track (previous track) by about 50%, a remaining signal is not greater than 50% so that it is practically difficult to directly employ the SWR method.

### SUMMARY

The inventive concept provides a hard disk drive (HDD) which may improve tracks per inch (TPI) without changing the width or material of a write head.

Additional aspects and utilities of the present general inventive concept will be set forth in part in the description which follows and, in part, will be obvious from the description, or may be learned by practice of the present general inventive concept.

Embodiments of the present inventive concept provide a hard disk drive including a magnetic head to write data to a disk by magnetizing the disk using a leakage magnetic flux that leaks in a disk direction through a write gap provided between a write pole to apply a magnetic field to the disk and a shield provided separately from the write pole, and an actuator arm that allows the magnetic head to pivot over the disk, wherein the write gap is asymmetrically formed to left and right with respect to a center axis line of the write pole according to a movement direction of the magnetic head when the magnetic head pivots over the disk.

The write gap may increase from one side to the other side so that a stronger write field is formed in the other side than that in the one side.

The write gap may linearly increase.

The write gap may increase in the form of a step.

The write gap may be constant in a predetermined section.

The write gap may be constant in a predetermined section in the one side and may linearly increase in a predetermined section in the other side.

In the write gap, a surface of the shield facing a surface of the write pole may be arranged to be inclined.

The write gap may be formed by processing a lower surface of the write pole facing the disk.

The magnetic head may include a write head to write data to the disk, and a read head comprising a read sensor to read data written to the disk, wherein the width of the read sensor is not more than half of the width of the write head for forming the write gap.

The write pole may have a trapezoidal sectional shape.

Embodiments of the present inventive concept also provide a hard disk drive including a magnetic head including a write pole to write data to a disk using a leakage magnetic flux that leaks in a disk direction, a read head disposed adjacent to the write head and having a shield layer provided to at least one side of the read head and a write gap provided between the write pole the shield layer to allow the leakage magnetic flux to reach the disk, the write gap being asymmetrically formed to a left side and a right side with respect to a center axis line of the write pole in a direction of movement of the magnetic head when the magnetic head pivots over the disk.

Embodiments of the present inventive concept also provide a hard disk drive having a magnetic head including a write pole to provide a magnetic field toward a disk of the disk drive, a read head including a shield member disposed at one side thereof closest to the write pole, and a write gap disposed between the write pole and the shield member to allow the magnetic field to leak toward the disk between the write pole and the shield member, the write gap being asymmetrically provided with respect to a central axis of the write pole extending in a direction in which the magnetic head moves along the disk.

### BRIEF DESCRIPTION OF THE DRAWINGS

Exemplary embodiments of the present general inventive concept will be more clearly understood from the following detailed description taken in conjunction with the accompanying drawings in which:

FIG. 1 is an exploded perspective view of an HDD according to an exemplary embodiment of the present inventive concept;

FIG. 2 schematically illustrates a structure of a leading end portion of the actuator arm of FIG. 1;

FIG. 3 is a side sectional view of a magnetic head of the HDD of FIG. 1;

FIG. 4 conceptually illustrates a write gap of a magnetic head of the HDD of FIG. 1;

FIG. 5 illustrates a process that a magnetic head of the HDD of FIG. 1 writes data;

FIG. 6 conceptually illustrates a write gap of a magnetic head of an HDD according to another exemplary embodiment of the present inventive concept; and

FIG. 7 conceptually illustrates a write gap of a magnetic head of an HDD according to a third exemplary embodiment of the present inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

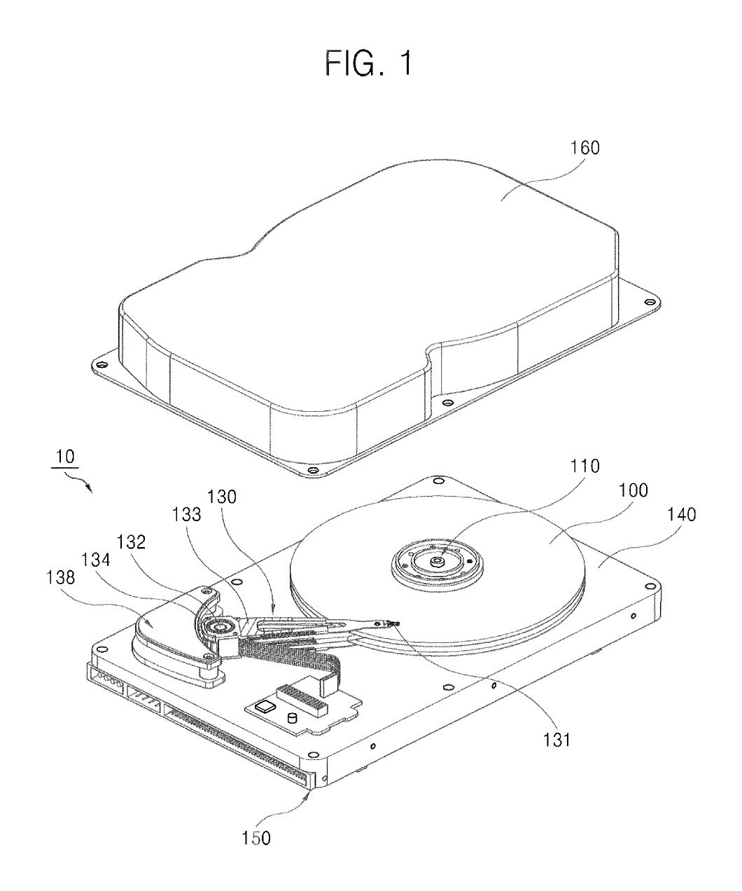

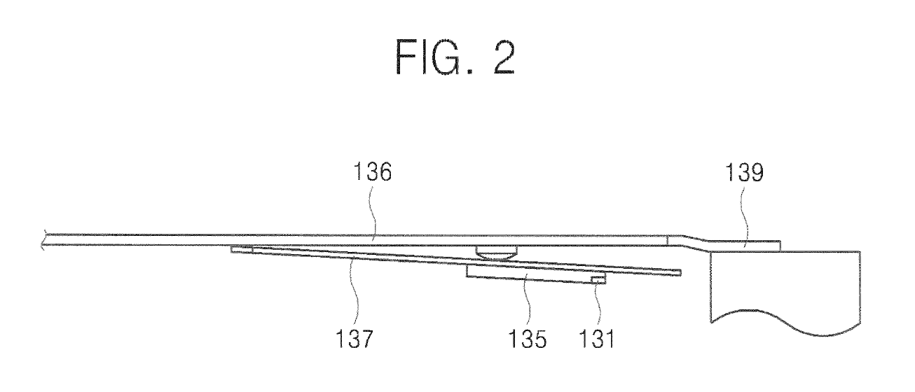

FIG. 1 is an exploded perspective view of a hard disk drive (HDD) 10 according to an exemplary embodiment of the present inventive concept. FIG. 2 schematically illustrates a structure in which a magnetic head is coupled to a leading end portion of an actuator arm of FIG. 1.

Referring to FIGS. 1 and 2, the HDD 10 includes a disk pack (not shown) having a disk 100 to record and store data and a spindle motor 110 to support and rotate the disk 100, a head stack assembly (HSA) 130 to read out data on the disk 100, a base 140 on which the above constituent elements are assembled, a printed circuit board assembly (PCBA) 150 coupled to a lower portion of the base 140 and controlling various elements by using most circuit parts mounted on a printed circuit board (PCB), and a cover 160 to cover an upper portion of the base 140.

The HSA 130, which is a carriage to record data on the disk 100 or read out data recorded on the disk 100, includes a magnetic head 131 to write or read data with respect to the disk 100, an actuator arm 133 that pivots around a pivot shaft 132 over the disk 100 to allow the magnetic head 131 to access data on the disk 100, a pivot shaft holder 134 which rotatably supports the pivot shaft 132, to which the actuator arm 133 is coupled by being supported thereon, and a bobbin (not shown) with a voice coil (not shown) wound therearound, the bobbin extending from the pivot shaft holder 134 in the opposite direction to the actuator arm 133 and disposed between magnets of a voice coil motor (VCM).

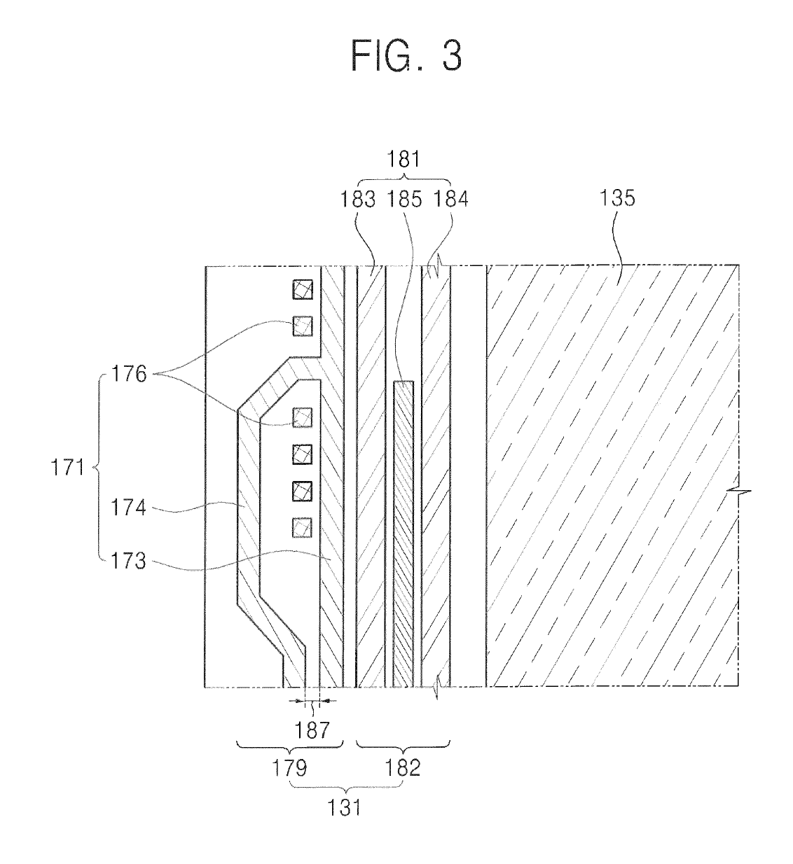

The magnetic head 131 reads or writes information with respect to the disk 100 that is rotating by detecting a magnetic field formed on a surface of the disk 100 or magnetizing the surface of the disk 100. The magnetic head 131 consists of a read head 182 (refer to FIG. 3) to read data of a track and a write head 179 (refer to FIG. 3) to write data to a track. In the present exemplary embodiment, the magnetic head 131, especially the write head 179 part of the magnetic head 131, has a different structure from a conventional write head so that tracks per inch (TPI) may be improved (i.e., increased) without changing the width or material of the write head 179, which will be described in detail below.

As it is illustrated in detail in FIG. 2, a slider 135 having the magnetic head 131 mounted thereon and a suspension 136 supporting the slider 135 to be elastically biased toward a surface of the disk 100 are provided at one end portion of the actuator arm 133. The slider 135 is supported on the suspension 136 by being attached to a flexure 137. Also, an end tab 139 extending from an end portion of the suspension 136 is installed at the end portion of the suspension 136.

The VCM 138 is a type of a drive motor to pivot the actuator arm 133 of the HSA 130 so as to move the magnetic head 131 to a desired position on the disk 100, by using the Fleming's left hand rule, that is, a force is generated when current flows in a conductive body located in a magnetic field. As current is applied to a voice coil located between the magnets, a force is applied to the bobbin so as to pivot the bobbin.

Accordingly, the actuator arm 133 pivots in a predetermined direction so that the magnetic head 131 installed at an end portion of the actuator arm 133 may move in a radial direction of the disk 100 while the disk 100 is rotating, to search for and access a track. Thus, the magnetic head 131 may write data to the disk 100 or read data from the disk 100.

As described above, in the HDD 10 according to the present exemplary embodiment, the magnetic head 131, especially the write head 179 portion of the magnetic head 131, has a different structure from a conventional one, which will be described in detail below.

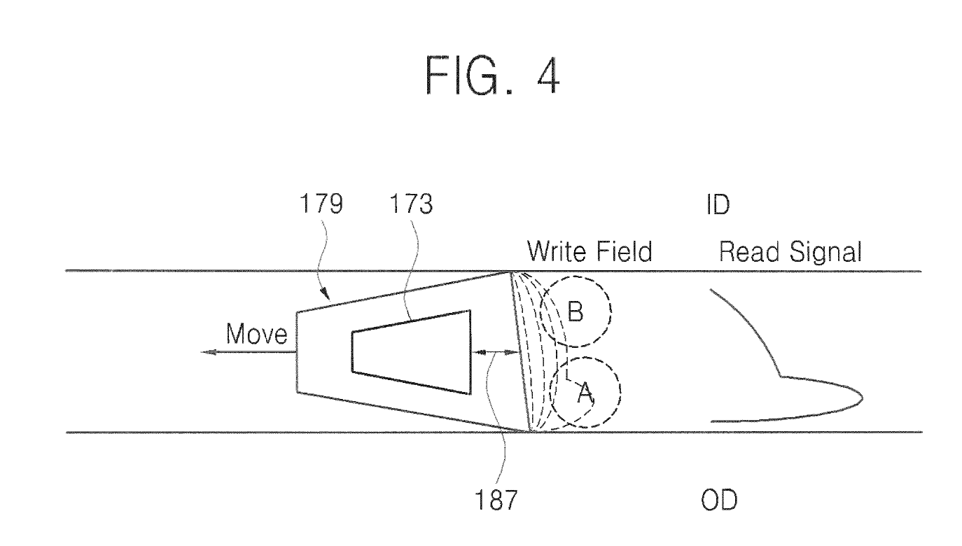

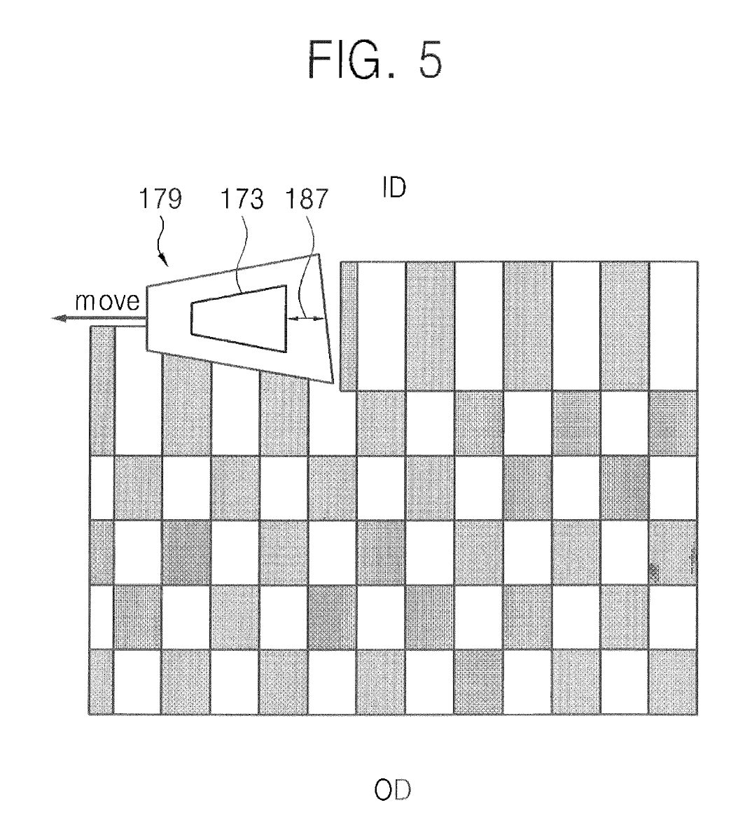

FIG. 3 is a side sectional view of the magnetic head 131 of the HDD 10 of FIG. 1. FIG. 4 conceptually illustrates a write gap of the magnetic head 131 of the HDD 10 of FIG. 1. FIG. 5 illustrates a process in which the magnetic head 131 of the HDD 10 of FIG. 1 writes data.

Referring to FIGS. 3-5, the magnetic head 131 of the HDD 10 according to the present exemplary embodiment includes the write head 179 and the read head 182. The write head 179 includes a magnetic field generation unit 171 to write data to the disk 100. The read head 182 includes a magnetic field detection unit 181 having a read sensor 185 to read written data.

The magnetic field generation unit 171 includes a write pole 173 to apply a magnetic field to the disk 100, a write shield 174 to form a magnetic path of a magnetic field with the write pole 173, and an induction coil 176 to induce a magnetic field around the write pole 173.

In the present exemplary embodiment, the write pole 173 may be formed of a magnetic material such as FeNi to substantially have a trapezoidal sectional shape. An electric signal corresponding to data to be written is applied from the PCBA 150 to the induction coil 176.

Data is recorded as the disk 100 is magnetized by a leakage magnetic flux that leaks downward through a width between the write pole 173 and a write shield 174 adjacent to the write pole 173, that is, a write gap 187. As the size of the write gap 187 increases, a stronger write field may be formed.

The magnetic field detection unit 181 includes the read sensor 185 provided at one side of the magnetic field generation unit 171 to read data written to a magnetic layer of the surface of the disk 100, shield layers 183 and 184 arranged at both sides of the read sensor 185 to protect inner parts including the read sensor 185, and a lead wire (not shown) to transfer a change in magnetoresistance according to a change in magnetic flux on the disk 100 detected by the read sensor 185. The magnetic field detection unit 181 reads data by detecting a magnetic signal written to the disk 100. The shield layers 183 and 184 are formed of non-magnetic material, unlike the write pole 173.

As described above, according to the shingle writing (SWR) method, when data is written to a disk 100, by using the write head 179, overlapping the next track (previous track) by about 50%, not more than 50% of a signal is left and then the read head 182 reads the remaining signal. Thus, it is very difficult to successfully employ the SWR method.

To address the above issue, relative to the write head 179 according to the present exemplary embodiment, as illustrated in FIG. 4, the write gap 187 is provided to be asymmetrical to the left and right with respect to a center axis line of the write pole 173 according to a movement direction (pivot direction) of the write head 179 when the magnetic head 131 pivots over the disk 100. The center axis line of the write pole 173 signifies a center axis line of the write pole 173 formed in a cross direction to a radial direction of the disk 100 when the write head 179 is arranged above the disk 100 for a write operation.

That is, in the write head 179 according to the present exemplary embodiment, the write gap 187 is formed to be asymmetrical to the left and right with respect to the center axis line of the write pole 173 according to a movement direction (pivot direction) of the write head 179 such that a signal remaining after the write head 179 writes data to a track overlapping the next track may be greater than a signal that is erased. Accordingly, when the write gap 187 is asymmetrically formed with respect to the center axis line of the write pole 173 according to the movement direction of the write head 179, the strength of a write field is asymmetrically formed such that a relatively strong write field is formed in a portion where the write gap 187 is large. As a result, a relatively strong data signal is formed in the portion where the write gap 187 is large.

In the SWR method, when data is written to the disk 100, data may be sequentially written from a track adjacent to an outer diameter (OD) of the disk 100 to a track adjacent to an inner diameter (ID) thereof, or reversely from a track adjacent to the ID of the disk 100 to a track adjacent to the OD thereof. In the present exemplary embodiment, data is sequentially written from a track adjacent to the OD of the disk 100 to a track adjacent to ID thereof.

In consideration of the above description, in the present exemplary embodiment, the write gap 187 linearly increases. In detail, the write gap 187 gradually increases from one side closer to the ID of the disk 100 to the other side closer to the OD thereof. The write gap 187 may be provided as a surface of the write shield 174 facing the write pole 173 is arranged to be inclined with respect to the write pole 173.

When the write gap 187 is formed as described above, as illustrated in FIG. 4, a stronger write field is formed in one portion (area A) of the write head 179 than that of the other portion (area B), as illustrated by the dotted line. Even when the write head 179 writes data overlapping the adjacent next track by a predetermined rate, for example, about 50%, the data written to the area A is not erased so that a larger amount of a data signal is left in the area A than that existing in the area B.

As such, even when the read head 182 of the magnetic head 131 to read the area A is manufactured to have a width that is much smaller than that of the write head 179 in order to reproduce data information written to a track, since there is no problem in reproduction of data information, TPI may be increased without changing the width or material of the write head 179.

Thus, in the present exemplary embodiment, the width of the read sensor 185 is formed to be not more than 50% of the width of the write head 179 in forming the write gap 187. The width of the read sensor 185 and the width of the write head 179 when forming the write gap 187 signify a width of the write head 179 in forming the write gap 187 with the read sensor 185 in a radial direction of the disk 100 when the magnetic head 131 is arranged adjacent to the disk 100 to read or write data.

In the operation of the HDD 10 configured as described above, when power is applied to the HDD 10 and a read and write operation starts, the disk 100 is rotated by the spindle motor 110 and the actuator arm 133 moves the magnetic head 131 to a predetermined position on the disk 100 so that a read and write operation is performed.

In the present exemplary embodiment, as illustrated in FIG. 5, the magnetic head 131 writes data by the SWR method in which, when data is written to a track, the data is written overlapping an adjacent track at a predetermined rate. In detail, when data is written to the disk 100, by allowing the data to be written while overlapping the next track (previous track) at a predetermined rate, for example, about 50%, about 50% of previously written data information is erased and the remaining 50% remains.

Unlike to a conventional technology, since the write gap 187 of the write head 179 of the magnetic head 131 according to the present exemplary embodiment is asymmetrically formed with respect to the center axis line of the write pole 173 according to the movement direction of the write head 179, the strength of a write field is asymmetrically formed to the left and right so that a large amount of a data signal, as compared to the conventional technology, is formed in a portion where the write gap 187 is large, that is, a remaining data signal. Thus, at least 50% of a total data signal written by the write head 179 remains.

To reproduce data information that is already recorded, the read head 182 of the magnetic head 131 is manufactured to be much smaller than the write head 179 and reads the remaining data signal. Thus, a larger amount of data information may be recorded or reproduced with respect to a disk as compared to the conventional technology so that TPI may be increased without changing the width or material of the write head 179.

A variety of exemplary embodiments of the present inventive concept will be described below. Since other structures except for the magnetic head 131 are the same as those in the above-described exemplary embodiment, descriptions on the other structures that are repeated will be omitted herein. Also, structures illustrated in the drawings for other exemplary embodiments, but not described in the present embodiment, are the same as those in the above-described exemplary embodiment, the descriptions on the structures in the above-described exemplary embodiment are used in a similar manner, and descriptions on the structures will be omitted herein. Also, in the following exemplary embodiments, data is sequentially written from a track adjacent to an outer circumference of a disk to a track adjacent to an inner circumference thereof.

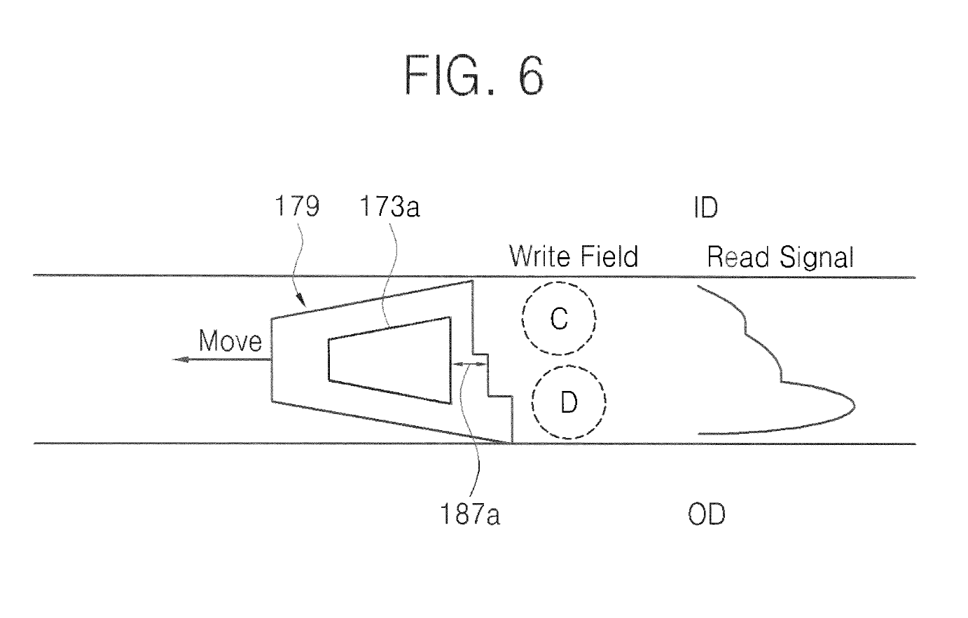

FIG. 6 conceptually illustrates a write gap of a magnetic head of an HDD according to another exemplary embodiment of the present inventive concept. The HDD according to the present exemplary embodiment is the same as the HDD 10 according to the above-described exemplary embodiment, except that a write gap 187a is formed in the shape of a step. The write gap 187a formed in the shape of a step may be provided by forming a surface of a write shield (not shown) facing a surface of the write pole 173a in the shape of a step.

In FIG. 6, an area C where a weak write field is formed exists and an area D where a relatively stronger write field than that in the area C is formed exists. Thus, as it is described in the above-described exemplary embodiment, a stronger write field is formed in one portion (area D) of the write head 179 than in the other portion (area C) thereof. Even when the write head 179 writes data overlapping the adjacent next track at a predetermined rate, for example, about 50%, the data written to the area D is not erased so that a larger amount of a data signal than that of a data signal originally existing in the area C remains in the area D.

Since the read head 182 of the magnetic head, which reads the area D to reproduce the data information that is already written to a track, has no problem in reading the data information even when the read head 182 is manufactured to be much smaller than the write head 179, TPI may be increased without changing the width or material of the write head 179, as compared to the conventional technology.

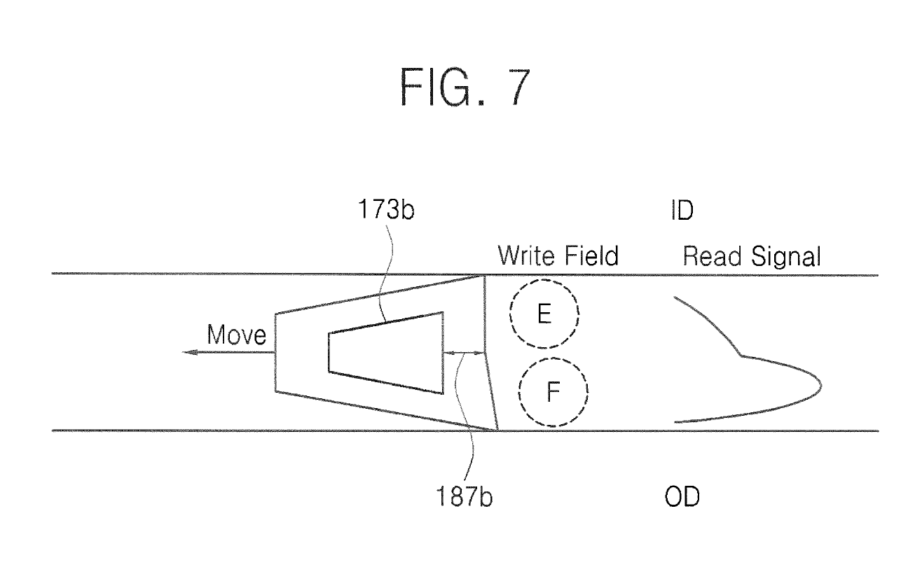

FIG. 7 conceptually illustrates a write gap of a magnetic head of an HDD according to yet another exemplary embodiment of the present inventive concept. In the HDD according to the present exemplary embodiment, a write gap 187b is constantly formed in an area E corresponding to the area C of FIG. 6, whereas the write gap 187b is formed to gradually increase in an area F corresponding to the area D of FIG. 6.

In FIG. 7, the area E where a weak write field is formed exists and the area F where a relatively stronger write field than that in the area E is formed exists. Accordingly, even when the write head 179 writes data overlapping the adjacent next track at a predetermined rate, for example, about 50%, the data written to the area F is not erased so that a larger amount of a data signal than that of a data signal originally existing in the area E remains in the area F.

Since the read head 182 of the magnetic head which reads the area F to reproduce the data information that is already written to a track, has no problem in reading the data information even when the read head 182 is manufactured to be much smaller than the write head 179, TPI may be increased without changing the width or material of the write head 179, as compared to the conventional technology.

In an HDD according to still another exemplary embodiment of the present inventive concept, unlike the above-described exemplary embodiments, a surface of a write pole (not shown) close to a disk, that is, a lower surface of the write pole, has a shape of obliquely cutting from a corner at one side to form the write gap (not shown) to be asymmetrical to the left and right with respect to a center axis line of the write pole according to a movement direction (pivot direction) of the write head.

Accordingly, an erase area close to the ID of a disk where a write field is weakly formed and a remaining area where a relatively stronger write field is formed as compared to the erase area exists. As such, since the data written to the remaining area is not erased even when the write head writes data to the adjacent next track at a predetermined rate, for example, about 50%, a larger amount of a data signal than that of a data signal originally existing in the erase area is left in the remaining area.

Since the read head of the magnetic head that reads the remaining area to reproduce the data information that is already written to a track has no problem in reading the data information even when the read head is manufactured to be much smaller than the write head, TPI may be increased without changing the width or material of the write head, as compared to the conventional technology.

Although in the above-described exemplary embodiments a case of writing data, by using the write head 179, overlapping an adjacent next track by about 50% in employing the SWR method is described, the scope of the present inventive concept is not limited thereto and data may be written, by using the write head 179, overlapping an adjacent next track by about 30%, 40%, or at any other appropriately set rate.

Also, although in the above-described exemplary embodiments a case of sequentially writing data from a track adjacent to the OD of a disk to a track adjacent to the ID thereof is described, data may be sequentially written from a track adjacent to the ID of a disk to a track adjacent to the OD thereof. In this case, a write gap is provided such that a write field is formed to be relatively stronger in the 10 of the disk than that in the OD thereof.

As described above, according to the present inventive concept, an HDD may improve TPI without changing the width or material of a write head.

While the present general inventive concept has been particularly shown and described with reference to exemplary embodiments thereof, it will be understood that various changes in form and details may be made therein without departing from the spirit and scope of the following claims.

What is claimed is:

1. A hard disk drive comprising:
a magnetic head to write data to a disk by magnetizing the disk using a leakage magnetic flux that leaks in a disk direction through a write gap provided between a write pole to apply a magnetic field to the disk and a write shield provided separately from the write pole; and
an actuator arm allowing the magnetic head to pivot over the disk,
wherein the write gap is asymmetrically formed to a left side and a right side with respect to a center axis line of the write pole according to a movement direction of the magnetic head when the magnetic head pivots over the disk.

2. The hard disk drive of claim 1, wherein the write gap increases from one side to the other side so that a stronger write field is formed in the other side than that in the one side.

3. The hard disk drive of claim 2, wherein the write gap linearly increases.

4. The hard disk drive of claim 2, wherein the write gap increases in a shape of a step.

5. The hard disk drive of claim 2, wherein the write gap is constant in a predetermined section.

6. The hard disk drive of claim 5, wherein the write gap is constant in a predetermined section in one side and linearly increases in a predetermined section in another side.

7. The hard disk drive of claim 2, wherein, in the write gap, a surface of the shield facing a surface of the write pole is arranged to be inclined.

8. The hard disk drive of claim 1, wherein the magnetic head comprises:
a write head to write data to the disk; and
a read head comprising a read sensor to read data written to the disk,
wherein the width of the read sensor is not more than half of the width of the write head to form the write gap.

9. The hard disk drive of claim 1, wherein the write pole has a trapezoidal sectional shape.

10. A hard disk drive comprising:
a write head including a write pole to write data to a disk using a leakage magnetic flux that leaks in a disk direction;
a write shield provided to at least one side of the write head; and
a write gap provided between the write pole and the write shield to allow the leakage magnetic flux to reach the disk, the write gap being asymmetrically formed to a left side and a right side with respect to a center axis line of the write pole in a direction of movement of the magnetic head when the magnetic head pivots over the disk.

11. The hard disk drive of claim 10, wherein the write gap increases from one side to another other side so that a stronger write field is formed at the other side than at the one side.

12. The hard disk drive of claim 11, wherein the write gap linearly increases.

13. The hard disk drive of claim 11, wherein the write gap increases in a shape of a step.

14. The hard disk drive of claim 11, wherein, in the write gap, a surface of the shield facing a surface of the write pole is arranged to be inclined.

15. A hard disk drive, comprising:
a magnetic head including:
a write pole to provide a magnetic field toward a disk of the disk drive,
a shield member disposed at one side thereof closest to the write pole, and
a write gap disposed between the write pole and the shield member to allow the magnetic field to leak toward the disk between the write pole and the shield member, the write gap being asymmetrically provided with respect to a central axis of the write pole extending in a direction in which the magnetic head moves along the disk.

16. The hard disk drive of claim 15, wherein the write gap increases from one side to the another side so that a stronger write field is formed in the other side than that in the one side.

17. The hard disk drive of claim 16, wherein the write gap is constant in a predetermined section.

18. The hard disk drive of claim 17, wherein the write gap is constant in a predetermined section in one side and linearly increases in a predetermined section in another side.
